(19) United States
(12) Patent Application Publication
(10) Pub. No.: US 2025/0165960 A1
(43) Pub. Date: May 22, 2025

(54) DYNAMIC HIERARCHICAL LEDGER

(71) Applicant: BillGo, Inc., Fort Collins, CO (US)

(72) Inventor: Ravi Wijayasekara, Fort Collins, CO (US)

(21) Appl. No.: 18/950,947

(22) Filed: Nov. 18, 2024

Related U.S. Application Data
(60) Provisional application No. 63/600,321, filed on Nov. 17, 2023.

(51) Int. Cl. G06Q 20/38

(52) U.S. Cl. CPC G06Q 20/38

(57) ABSTRACT

Aspects of the present disclosure relate to a dynamic hierarchical ledger, where a hierarchy with which processing is performed by the disclosed ledger system is user-definable, thereby enabling variable granularity and structure. The disclosed aspects may thus improve transaction management, the data analytics capabilities of the ledger system, and/or provide an improved user experience, among other benefits.

### CROSS-REFERENCE TO RELATED APPLICATION

This application claims priority to U.S. Provisional Application No. 63/600,321, titled “Dynamic Hierarchical Ledger,” filed on Nov. 17, 2023, the entire disclosure of which is hereby incorporated by reference in its entirety.

### BACKGROUND

Tracking and managing transactions for a number of user accounts is a challenging task. For example, it can be difficult to maintain accuracy with a high volume of transactions and/or in instances where many transactions occur in a short period of time. Additionally, traditional management software may operate according to a rigid structure and corresponding set of rules, thereby complicating the applicability of such software to different contexts.

### SUMMARY

Aspects of the present disclosure relate to a dynamic hierarchical ledger, where a hierarchy with which processing is performed by the disclosed ledger system is user-definable, thereby enabling variable granularity and structure. The disclosed aspects may thus improve transaction management, the data analytics capabilities of the ledger system, and/or provide an improved user experience, among other benefits.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for a dynamic hierarchical ledger according to aspects of the present disclosure.

FIG. 2 illustrates an example of a dynamic hierarchy which may be used by a ledger system according to aspects described herein.

FIG. 3 illustrates an overview of an example method for processing a dynamic hierarchical ledger according to aspects described herein.

FIG. 4 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a hierarchical ledger is used to manage transactions (e.g., between a set of accounts). For instance, as a resource (e.g., data, items, money or currency, etc.) is transferred to or from an account, the ledger is updated to reflect such a transaction accordingly. As an example, an account may be a credit card account or a bank account, among other examples. Accounts for which the ledger is used may have a corresponding hierarchy. For instance, an organization may have a number of departments, offices, states (or other geographic region), or other divisions that each have one or more associated accounts. As such, the hierarchical ledger may enable management of and/or reporting for such accounts at a department level, an office level, a geographic region level, and/or a division level, among other examples, while also enabling management of multiple accounts at a higher level (e.g., such that multiple departments, offices, geographic regions, and/or divisions are aggregated for processing as a group).

However, different users may have organizational structures that differ from the structure contemplated by the hierarchical ledger, such that performing processing according to a rigid hierarchical structure may be inapplicable to the account structure of at least a subset of current and/or prospective users. This may result in user frustration, unexpected processing, difficulty in diagnosing issues, and/or prospective users foregoing use of the hierarchical ledger system altogether, among other detriments.

Accordingly, aspects of the present disclosure relate to a dynamic hierarchical ledger, where a hierarchy with which processing is performed by the disclosed ledger system is user-definable, thereby enabling variable granularity and structure. The disclosed aspects may thus improve transaction management, the data analytics capabilities of the ledger system, and/or provide an improved user experience, among other examples.

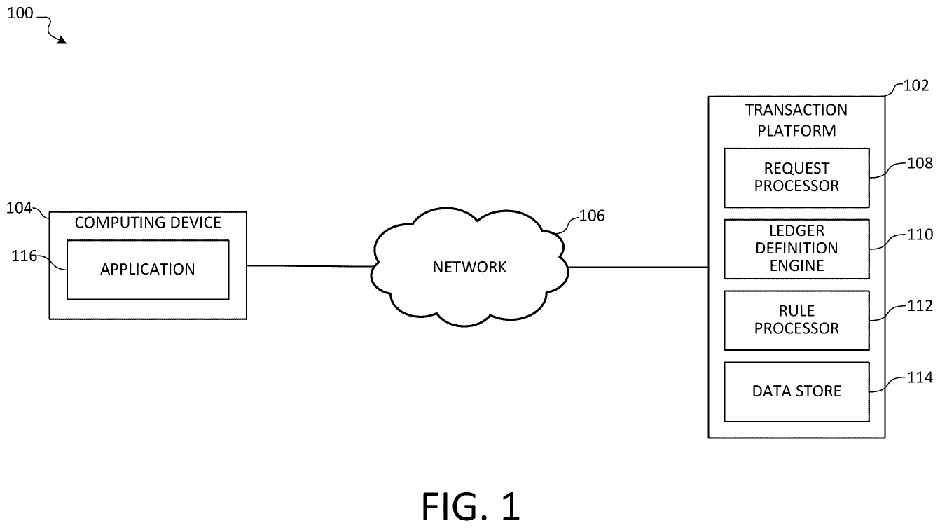

FIG. 1 illustrates an overview of an example system 100 for a dynamic hierarchical ledger according to aspects of the present disclosure. As illustrated, system 100 includes transaction platform 102, computing device 104, and network 106. For example, network 106 may comprise a local area network, a wireless network, or the Internet, or any combination thereof, among other examples.

Transaction platform 102 is illustrated as comprising request processor 108, ledger definition engine 110, rule processor 112, and data store 114. In examples, request processor 108 processes requests from a client device, such as from computing device 104. Examples of a request include, but are not limited to, a request to generate a report (e.g., based on a dynamic hierarchy), a request to manage a rule corresponding to a hierarchy (e.g., to create, delete, or edit a rule for one or more given nodes in the hierarchy), and/or a request to manage a ledger (e.g., to record a transaction, to manage the structure of an associated dynamic hierarchy, or to request the status of a transaction), among other examples. It will therefore be appreciated that request processor 108 may process any of a variety of requests made to transaction platform 102 according to aspects described herein.

Transaction platform 102 further comprises ledger definition engine 110, which manages a dynamic hierarchy for a given ledger according to aspects of the present disclosure. In examples, transaction platform 102 maintains multiple ledgers, each of which has an associated dynamic hierarchy that is managed by ledger definition engine 110 accordingly. In examples, a request is received via request processor is a request to edit a ledger hierarchy managed by ledger definition engine 110. For example, the request may add, delete, or edit nodes of the ledger hierarchy accordingly, thereby changing the structure of the dynamic hierarchical ledger with which transactions are managed. As another example, the request may be to manage one or more rules associated with the ledger hierarchy (e.g., as may be processed by rule processor 112).

As described herein, a dynamic ledger hierarchy comprises a set of nodes and associated edges, thereby defining a structure for a set of corresponding accounts. As an example, the dynamic ledger hierarchy has one or more hierarchical levels, where a node of a first level may have one or more nodes at a second (e.g., lower) level (also referred to herein as “sub-nodes”) that are each associated with the node by a respective edge of the set of edges. Sub-nodes of a corresponding node may thus be aggregated under that node, for example when processing one or more rules and/or when generating a report, among other examples. Similarly, a parent node of a given sub-node may itself be a sub-node for another parent node (e.g., at a higher level). It will therefore be appreciated that a dynamic ledger hierarchy according to aspects described herein may have any number of levels.

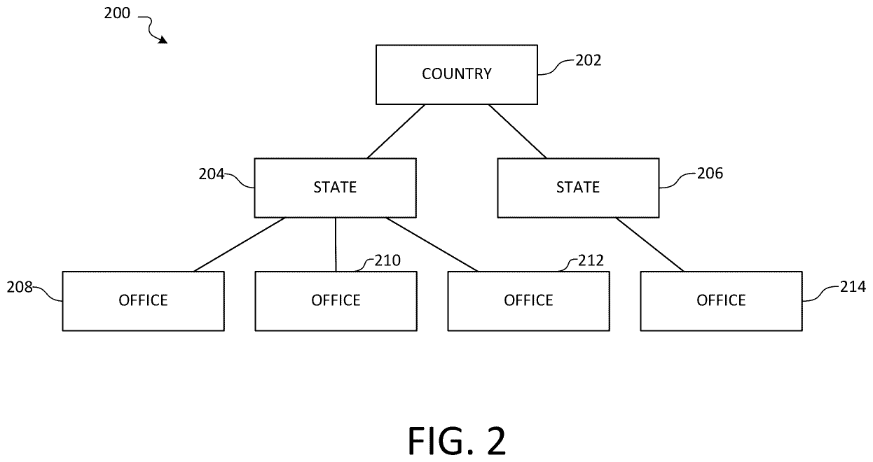

As an example, a dynamic ledger hierarchy may have a set of offices that are each sub-nodes for a given geographic region. Thus, each sub-node may be processed individually (e.g., at the office level of the dynamic ledger hierarchy) and/or the sub-nodes may be aggregated when processing a parent node for the corresponding geographic region (e.g., at the state level of the dynamic ledger hierarchy). Additionally, a given geographic region parent node may similarly be a sub-node for a country node, thereby enabling further sub-node aggregation at a country level of the dynamic ledger hierarchy. Additional examples of such aspects are discussed below with respect to FIG. 2.

It will be appreciated that, while an example hierarchy is described, any of a variety of other structures are contemplated. As an example, another user may specify a different structure that is more applicable to that user's specific use case. For instance, rather than offices, states, and countries, a dynamic hierarchical ledger may instead be organized according to a corporate structure (e.g., divisions and/or business units).

Rule processor 112 of transaction platform 102 processes a dynamic hierarchical ledger according to a set of rules. For example, a node of a dynamic hierarchy has one or more associated rules (e.g., relating to a credit limit, a reporting requirement, and/or a retention period). In examples, a user provides a request to request processor 108 to manage a set of rules for a dynamic hierarchical ledger, for example to define a new rule, delete a rule, and/or to modify a rule, among other examples. For instance, the user may define a rule for a given node and/or level of the hierarchical ledger.

Accordingly, rule processor 112 identifies one or more rules for a given node of the dynamic hierarchy (e.g., based on an association with the node and/or level of the hierarchy). Rule processor 112 identifies a set of nodes for an identified rule (e.g., including the node itself and one or more sub-nodes at a number of levels) and processes a corresponding set of accounts accordingly. Thus, a rule may correspond to one or more levels of the hierarchy, such that a set of nodes (e.g., including one or more levels of sub-nodes) is processed based on the rule accordingly.

For instance, rule processor 112 aggregates one or more metrics for the set of sub-nodes (e.g., a corresponding balance for each given sub-node) and compares the aggregated balance to a balance threshold, thereby determining if the set of accounts is within a credit limit that is defined by the rule for the parent node. As another example, rule processor 112 processes a set of rules to generate a report for the set of accounts, for example to provide aggregated and/or enumerated account information, among other examples. Example account information includes, but is not limited to, an account balance, a list of pending and/or completed transactions, and/or one or more dates (e.g., a bill close date and/or a payment due date), among other examples. It will therefore be appreciated that a rule may be associated with any number of nodes (e.g., corresponding to the entire dynamic ledger hierarchy or a subpart selected therefrom) and may be used to determine whether the nodes comply with a rule and/or to generate a report for an associated set of accounts, among other examples.

Transaction platform 102 further comprises data store 114, which stores the dynamic hierarchical ledger according to aspects described herein. In examples, data store 114 further stores account information (e.g., for accounts that each correspond to a node of the dynamic hierarchical ledger). Thus, ledger definition engine 110 may modify a dynamic hierarchical ledger stored in data store 114 in response to a request (e.g., as may be received via request processor 108). Similarly, rule processor 112 processes account information from data store 114 when processing a rule, among other examples. For instance, processing by rule processor 112 may additionally or alternatively comprise accessing account information from an external data source (not pictured). In examples, the information from the external data source is cached or otherwise stored in data store 114.

System 100 is further illustrated as comprising computing device 104, which may be any of a variety of computing devices, including, but not limited to, a desktop computing device, a laptop computing device, a tablet computing device, or a mobile computing device, among other examples. As illustrated, computing device 104 includes application 116. In examples, a user operates application 116 to interact with transaction platform 102, for example to request a report, to check compliance with a rule, and/or to manage a dynamic hierarchical ledger according to aspects described herein. Thus, a request made via application 116 may be processed by request processor 108 as described above.

FIG. 2 illustrates an example of a dynamic hierarchy 200 which may be used by a ledger system according to aspects described herein. For example, dynamic hierarchy 200 may be defined as a result of requests processed by a request processor (e.g., request processor 108 in FIG. 1), as may be received from an application of a computing device, such as application 116 of computing device 104. In examples, dynamic hierarchy 200 is managed by a ledger definition engine (e.g., ledger definition engine 110) and/or used by a rule processor (e.g., rule processed 112) when processing rules for a given ledger, among other examples.

As illustrated, dynamic hierarchy 200 includes country node 202, which has two sub-nodes: state node 204 and state node 206. Thus, country node 202 is a parent node to child nodes 204 and 206. Similarly, state node 204 has three sub-nodes: office node 208, office node 210, and office node 212, whereas state node 206 has a single sub-node: office node 214. While an example structure is provided, it will be appreciated that a dynamic hierarchical ledger may have any of a variety of other structures in other examples.

As noted above, a node and/or hierarchical level may have an associated rule, such that associated nodes may be processed accordingly. For instance, country node 202 may have an associated rule that is thus used to process nodes 202, 204, 206, 208, 210, 212, and 214. As another example, an associated rule of country node 202 may specify a number of levels to which the rule applies, thereby limiting a depth with which corresponding nodes are identified and processed. For example, the rule may limit processing to one subsequent level, thereby applying only to nodes 202, 204, and 206. It will also be appreciated that a rule need not apply to the node with which it is associated, such that a rule associated with country node 202 processes a set of sub-nodes without necessarily processing country node 202 itself. Similarly, a rule corresponding to state node 204 and/or state node 206 may thus process office nodes 208, 210, and 212, as well as office node 214, respectively.

As noted above, a rule may be used to process account information for associated accounts, for example to determine whether the rule is satisfied (e.g., such that a credit limit is not exceeded and/or a data retention requirement is met) and/or to generate a report accordingly, among other examples. In examples, a default dynamic hierarchy is provided by a transaction platform (e.g., transaction platform 102), a hierarchy library is provided (e.g., from which a user may select a dynamic hierarchical ledger structure), and/or a user is able to define a new dynamic hierarchical ledger structure from scratch, among other examples. Similarly, a set of default rules may be provided, a rule library may be available from which a user can select one or more rules, rules may be user-defined, and/or rules may be applied based on geographical requirements (e.g., local/state/regional laws), among other examples. It will therefore be appreciated that any of a variety of techniques may be used to provide a user experience with which to define and/or modify a dynamic hierarchical ledger according to aspects described herein.

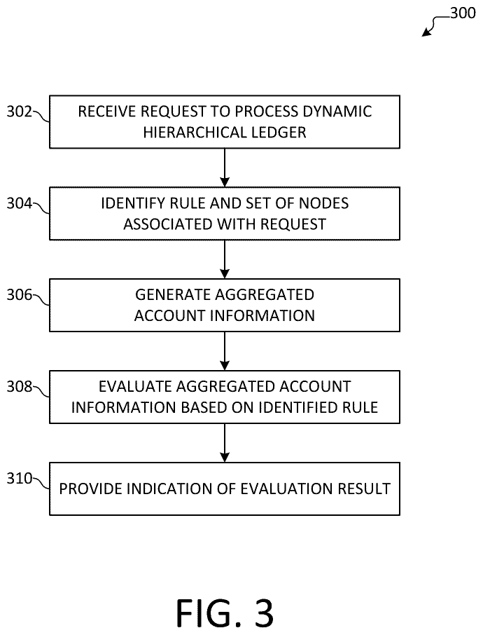

FIG. 3 illustrates an overview of an example method 300 for processing a dynamic hierarchical ledger according to aspects described herein. In examples, aspects of method 300 are performed by a transaction platform, such as transaction platform 102 discussed above with respect to FIG. 1.

As illustrated, method 300 begins at operation 302, where a request is received to process a dynamic hierarchical ledger. In examples, the request is received from a computing device (e.g., computing device 104 in FIG. 1), which may be executing an application similar to application 116 discussed above. For instance, a user operates the application to request a report for a given set of accounts and/or to determine whether a set of accounts is in compliance with a given rule. As another example, the request is received automatically, as may be the case when reporting and/or rule validation is performed automatically (e.g., periodically and/or in response to an event). For instance, aspects of method 300 are performed in response to a transaction for an account that is managed via the dynamic hierarchical ledger, as may be the case when a rule is used to evaluate a credit limit to determine whether to approve/reject the transaction, among other examples. In some instances, the request comprises an indication as to one or more rules and/or a set of accounts to be processed.

At operation 304, a rule and a set of nodes that are associated with the request are identified. In examples, operation 304 comprises accessing a dynamic hierarchical ledger structure from a data store, such as data store 114 in FIG. 1. Accordingly, the accessed dynamic hierarchical is processed to identify a rule (e.g., as may be associated with a node and/or level of the structure). In examples, the rule is identified based on an indication that was included in the request that was received at operation 302. As described above, the rule may comprise an indication as to a set of nodes for which the rule applies, such that at least a subset of nodes of the dynamic hierarchical ledger structure are identified accordingly. For example, the identified subset of nodes may include one or more sub-nodes of the node to which the rule applies.

Flow progresses to operation 306, where aggregated account information is generated for the subset of nodes that was identified at operation 304. In some examples, operation 306 comprises processing each node of the subset of identified nodes to obtain and/or aggregate account information accordingly. For instance, each node has one or more associated accounts for which the disclosed ledger system manages account information accordingly. In examples, account information is obtained from a data store of a transaction platform, such as data store 114 of transaction platform 102 discussed above with respect to FIG. 1. Additionally, or alternatively, operation 306 comprises accessing account information from another data source (e.g., a resource manager associated with one or more transactions with which the account is involved). In some instances, operation 306 comprises aggregating individual account information (e.g., for each account associated with an identified node) and/or generating summarized account information (e.g., a total balance, an average balance, etc.). Such aspects may be defined by the rule for which method 300 is being performed in some examples.

Moving to operation 308, the account information that was aggregated at operation 306 is processed according to the identified rule. In examples, operation 308 comprises evaluating individual account information for each identified account and/or evaluating summarized account information, among other examples. In some instances, a rule specifies one or more thresholds, ranges, and/or conditions with which the aggregated account information is processed. Additionally, or alternatively, a rule specifies data fields and/or a format with which the aggregated account information is to be reported. Thus, operation 308 may comprise determining whether the aggregated account information satisfies the identified rule and/or generating a report according to the identified rule.

While examples are described with respect to a single rule, it will be appreciated that similar aspects may be used to process multiple rules. For example, a rule may itself be hierarchical and/or have one or more dependent rules, among other examples. For instance, a sub-node may have an associated rule, such that evaluation of a rule for a parent node is dependent on the evaluation of one or more sub-node rules. Thus, as an example, if it is determined that a set of associated sub-nodes each are within a credit limit, it may be determined that the parent node is similarly within a credit limit.

At operation 310, an indication of the evaluation result is provided. For example, the evaluation result may be provided in response to the request that was received at operation 302 and/or may be stored in a data store (e.g., for auditing/reporting purposes). As an example, a generated report is provided to a computing device for display to a user or a rule evaluation result is provided for subsequent processing (e.g., to determine whether to allow/reject a transaction). It will therefore be appreciated that any of a variety of operations may be performed based on the result of processing a dynamic hierarchical ledger according to aspects described herein. As illustrated, method 300 terminates at operation 310.

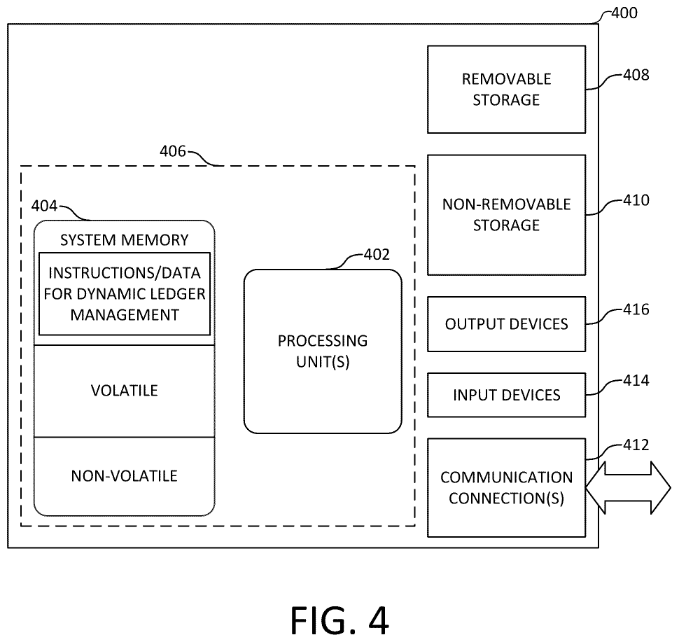

FIG. 4 illustrates an example of a suitable computing environment 400 in which one or more of the present embodiments may be implemented. For example, aspects of computing environment 400 may be used by a device, such as computing device 104 and/or a device of transaction platform 102 in FIG. 1. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 400 typically may include at least one processing unit 402 and memory 404. Depending on the exact configuration and type of computing device, memory 404 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as a keyboard, mouse, pen, voice input, etc. and/or output device(s) 416 such as a display, speakers, printer, etc. Also included in the environment may be one or more communication connections, 412, such as LAN, WAN, point to point, etc.

Computing environment 400 may include at least some form of computer readable media. The computer readable media may be any available media that can be accessed by processing unit 402 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 404. While executing on the processing unit 402, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
identifying a rule and an associated set of nodes from a dynamic hierarchical data structure;
processing the set of nodes based on the identified rule to generate an evaluation result; and
providing an indication of the evaluation result for the identified rule.

2. The system of claim 1, further comprising receiving, from a computing device, a change to the dynamic hierarchical data structure.

3. The system of claim 2, wherein the change comprises at least one of:
an indication of a rule for a node of the dynamic hierarchical data structure;
an indication of new node for the dynamic hierarchical data structure;
an indication to modify a node of the dynamic hierarchical data structure; or
an indication to delete a node of the dynamic hierarchical data structure.

4. The system of claim 2, wherein the indication of the evaluation result is provided to the computing device.

5. The system of claim 1, wherein providing the indication of the evaluation result comprises storing the evaluation result in a data store.

6. The system of claim 1, wherein the evaluation result comprises an indication that the set of nodes satisfies the identified rule.

7. The system of claim 1, wherein the evaluation result comprises a report generated according to the identified rule.

8. The system of claim 1, wherein the identified set of nodes is a subpart of the dynamic hierarchical data structure.

9. The system of claim 1, wherein the identified set of nodes comprises a node associated with the identified rule and one or more sub-nodes of the node.

10. The system of claim 1, wherein the rule and associated set of nodes is identified in response to a request and the indication of the evaluation result is provided in response to the request.

11. The system of claim 10, wherein the set of operations further comprises:
receiving a second request associated with a different dynamic hierarchical data structure;
processing a set of nodes of the different dynamic hierarchical data structure to generate another evaluation result; and
providing an indication of the another evaluation result in response to the second request.

12. A method for managing a hierarchical data structure, the method comprising:
identifying a change to at least one of a rule or a node of the hierarchical data structure;
obtaining a rule and an associated set of nodes from the hierarchical data structure that relate to the change to the hierarchical data structure;
processing the set of nodes based on the identified rule to generate an evaluation result; and
providing, to the computing device, an indication of the evaluation result for the identified rule.

13. The method of claim 12, wherein the change comprises at least one of:
an indication of a rule for a node of the hierarchical data structure;
an indication of new node for the hierarchical data structure;
an indication to modify a node of the hierarchical data structure; or
an indication to delete a node of the hierarchical data structure.

14. The method of claim 12, wherein the evaluation result comprises a report generated according to the identified rule.

15. The method of claim 12, wherein the identified set of nodes comprises a node associated with the identified rule and one or more sub-nodes of the node.

16. The method of claim 12, further comprising:
receiving a second request associated with a different hierarchical data structure;
processing a set of nodes of the different hierarchical data structure to generate another evaluation result; and
providing an indication of the another evaluation result in response to the second request.

17. A method for managing a hierarchical data structure, the method comprising:
identifying a rule and an associated set of nodes from a dynamic hierarchical data structure;
processing the set of nodes based on the identified rule to generate an evaluation result; and
providing an indication of the evaluation result for the identified rule.

18. The method of claim 17, wherein the evaluation result comprises an indication that the set of nodes satisfies the identified rule.

19. The method of claim 17, wherein the rule and associated set of nodes is identified in response to a request and the indication of the evaluation result is provided in response to the request.

20. The method of claim 17, further comprising:
receiving a second request associated with a different dynamic hierarchical data structure;
processing a set of nodes of the different dynamic hierarchical data structure to generate another evaluation result; and
providing an indication of the another evaluation result in response to the second request.
